(19) United States
(12) Patent Application Publication
(10) Pub. No.: US 2024/0151925 A1
(43) Pub. Date: May 9, 2024

(54) FIBER OPTIC MANAGEMENT TRAY

(71) Applicant: CommScope Technologies LLC, Hickory, NC (US)

(72) Inventors: Pieter VERMEULEN, Westerlo (BE); Johan GEENS, Bunsbeek (BE); Bart Mattie CLAESSENS, Hasselt (BE); Bart VOS, Geel (BE)

(73) Assignee: CommScope Technologies LLC, Hickory, NC (US)

(21) Appl. No.: 18/549,698

(22) PCT Filed: Mar. 11, 2022
(86) PCT No.: PCT/US2022/019917

§ 371 Date: Sep. 8, 2023

Related U.S. Application Data
(60) Provisional application No. 63/160,553, filed on Mar. 12, 2021.

(51) Int. Cl. G02B 6/44

(52) U.S. Cl. CPC G02B 6/4454; G02B 6/4447

(57) ABSTRACT

The present disclosure relates generally to fiber management trays that have features such as cable management structures positioned on the tray in such a way that its bend radius does not fall below a minimum bend radius of fiber. A bend radius limiter is positioned adjacent a cable entry region, where the bend radius limiter includes a raised support member elevated with respect to a base such that the bend radius limiter is offset upwardly from the base to define a cable routing pathway beneath the raised support member from the cable entry region to a fiber loop-storage region. The base can include adapters in a group that is asymmetrically positioned relative to a longitudinal axis of the tray.

### CROSS-REFERENCE TO RELATED APPLICATION

This application is being filed on Mar. 11, 2022 as a PCT International Patent Application and claims the benefit of U.S. Patent Application Ser. No. 63/160,553, filed on Mar. 12, 2021, the disclosure of which is incorporated herein by reference in its entirety.

### TECHNICAL FIELD

The present disclosure relates generally to telecommunications components. More particularly, the present disclosure relates to a tray for use in managing optical fibers in fiber optic telecommunications systems.

### BACKGROUND

As demand for telecommunications increases, networks are being extended in more and more areas. In facilities such as single family homes, multiple dwelling units (MDU's), apartments, condominiums, businesses, etc., boxes are used to provide subscriber access points to a telecommunications network. Cables are also used to interconnect the subscriber access points provided by boxes with subscribers at subscriber locations (e.g., at each residence).

Various boxes or enclosures for telecommunications equipment are known. The boxes used for subscriber access points can have various forms depending on such factors as the environment, the space requirements for containing telecommunications equipment, and the type of technician access needed for the telecommunications equipment. These and other considerations are related to box design and usability.

Fiber management trays are commonly used in boxes to effectively manage and protect optical fiber in a fiber optic communication system. A typical fiber management tray provides splicing and fiber management functionality. Fiber management trays may be single-sided or double-sided and are often arranged in a stack with the individual fiber management trays being pivotally mounted relative to one another. Excess optical fibers may be stored on the fiber management trays in such a way that its bend radius does not fall below a minimum bend radius of the fiber (i.e., the minimum safe radius at which the fiber may be bent without causing damage to the fiber or causing signal loss in the fiber).

There is a continued need for improvement in tray designs where a bend radius of optical fiber does not fall below a minimum bend radius resulting in a lower risk of optical losses.

### SUMMARY

The present disclosure relates generally to fiber management trays that have features such as cable management structures positioned on the tray in such a way that its bend radius does not fall below a minimum bend radius of fiber (i.e., the minimum safe radius at which the fiber may be bent without causing damage to the fiber or causing signal loss in the fiber).

One aspect of the disclosure concerns fiber loop storage tray a main tray body including a base panel having a top side, opposite first and second sides extending between opposite first and second ends, and fiber guide walls that project upwardly from the top side of the base panel to define a fiber loop-storage region on the top side of the base panel. A bend radius limiter is positioned adjacent a cable entry region, the bend radius limiter including a raised support member elevated with respect to the base panel such that the bend radius limiter is offset upwardly from the base panel to define a cable routing pathway beneath the raised support member from the cable entry region to the fiber loop-storage region.

A further aspect of the disclosure concerns a patch tray including adapter holders and adapters for connection with mating fiber optic connectors of cables managed on an organizer. The adapter holders are asymmetrically positioned with respect to a longitudinal axis of the patch tray. Cables extending from the adapter holder in a direction opposite a cable entry location are stored in loops at an upper end of the patch tray. An opening at the upper end of the patch tray allows for those cables to extend to other areas of the organizer. A pocket under the adapter holder further receives the storage loops.

These and other features and advantages will be apparent from a reading of the following detailed description and a review of the associated drawings. A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### BRIEF DESCRIPTION OF THE DRAWINGS

The following drawings are illustrative of particular embodiments of the present disclosure and therefore do not limit the scope of the present disclosure. Embodiments of the present disclosure will hereinafter be described in conjunction with the appended drawings, wherein like numerals denote like elements.

FIG. 1 illustrates a perspective view of an example telecommunications enclosure configured in accordance with the principles of the present disclosure, the telecommunications enclosure including a housing having a cover and a base.

FIG. 2 illustrates a bottom perspective view of the telecommunications enclosure of FIG. 1.

FIG. 3 illustrates the telecommunications enclosure of FIG. 1 showing a management unit including a splice tray exploded out of the housing.

FIG. 4 illustrates a top view of the management unit of FIG. 3.

FIG. 5 illustrates a perspective view of the management unit of FIG. 3 with flat drop cables.

FIG. 6 illustrates a top view of the management unit of FIG. 3 with round drop cables.

FIG. 7 illustrates a perspective view of the management unit of FIG. 6.

FIGS. 8-13 illustrate multiple views of the splice tray of FIG. 5 depicting a bend radius limiter in accordance with the principles of the present disclosure.

FIG. 14 illustrates the telecommunications enclosure of FIG. 1 with another management unit that includes an adapter module in accordance with the principles of the present disclosure.

FIG. 15 illustrates a further enlarged perspective view of the management unit of FIG. 14.

FIG. 16 illustrates a top view of the management unit of FIG. 15.

### DETAILED DESCRIPTION

Various embodiments of the present invention will be described in detail with reference to the drawings, wherein like reference numerals represent like parts and assemblies throughout the several views. Reference to various embodiments does not limit the scope of the invention. Additionally, any examples set forth in this specification are not intended to be limiting and merely set forth some of the many possible embodiments.

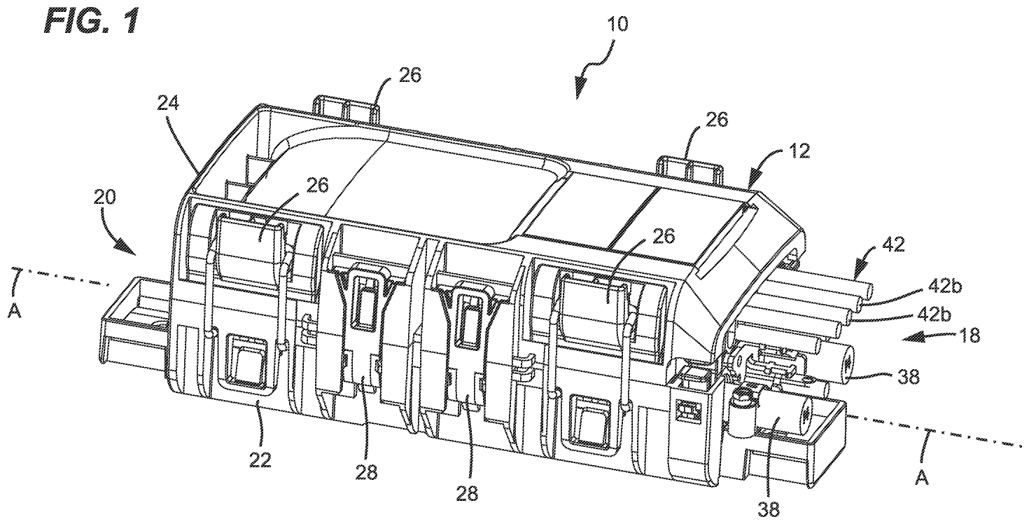

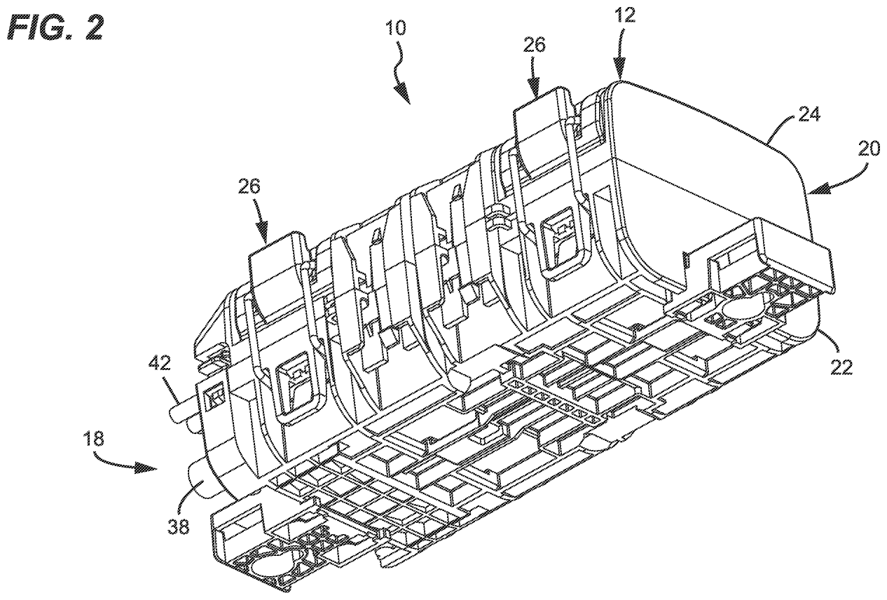

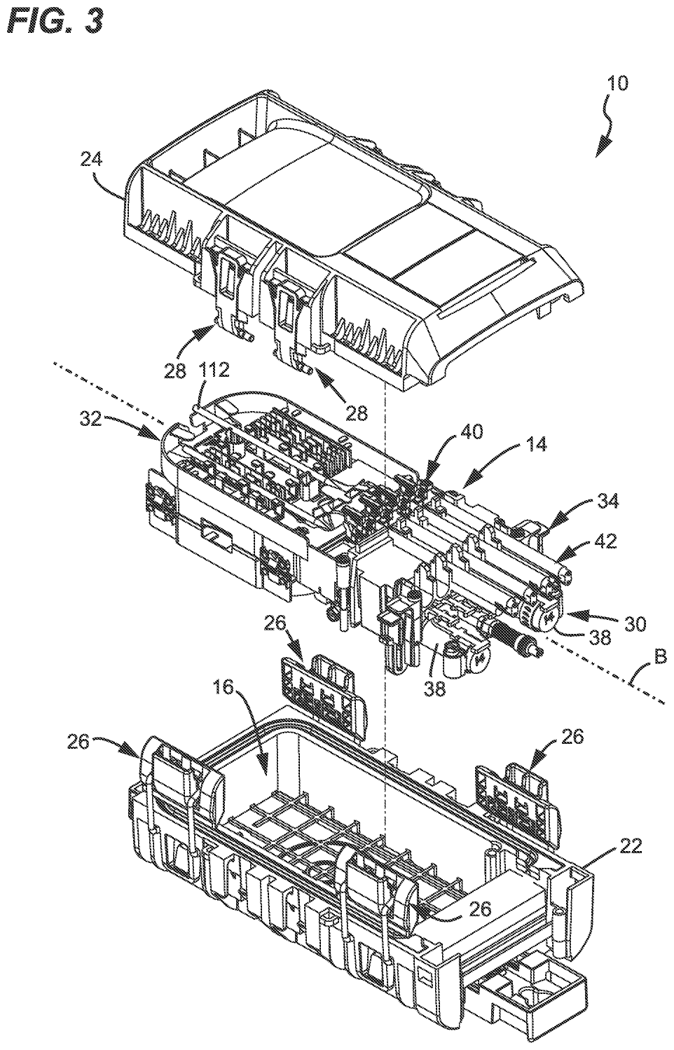

As presented at FIGS. 1-3, an example telecommunications enclosure 10 is shown in accordance with the principles of the present disclosure. The telecommunications enclosure 10 can be a re-enterable enclosure 10 that includes a housing 12 and a management unit 14 that mounts within an interior 16 of the housing 12. Example telecommunications enclosures are disclosed at PCT International Patent Application No. PCT/US2019/017904 filed on Feb. 13, 2019, published as WO2019/160995, the disclosure of which is hereby incorporated by reference. Fiber management trays disclosed herein and can be used for accommodating various fiber routing configurations, splice configurations, splitter configurations, adapter mounting locations, etc. The housing 12 is elongate along a major axis A of the housing 12. The major axis A extends along a length of the housing 12 between first and second opposite ends 18, 20.

The housing 12 includes a bottom portion 22 (e.g., a bottom half-portion, base) and a top portion 24 (e.g., a top half-portion, cover) that cooperate to define an interior of the housing 12. The bottom and top portions 22, 24 can meet at a sealed interface that can be sealed by a perimeter gasket (not shown) or other structure. The bottom and top portions 22, 24 can be clamped together via side clamps 26 (e.g., perimeter latches) that compress the bottom and top portions 22, 24 together to compress the gasket therein between for sealing. It will be appreciated that the side clamps 26 can be unlatched to provide access to the interior of the telecommunications enclosure 10. Thus, the telecommunications enclosure 10 is readily re-enterable. In certain examples, the top portion 24 can be pivotally connected to the bottom portion 22 and can be pivotally moveable relative to the bottom portion 22 between an open position and a closed position via hinge members 28.

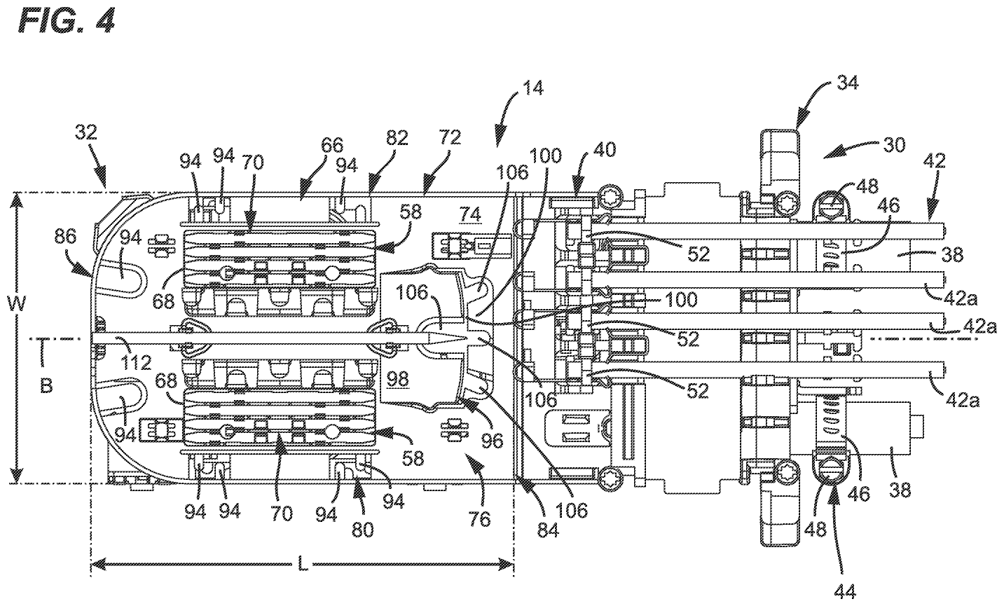

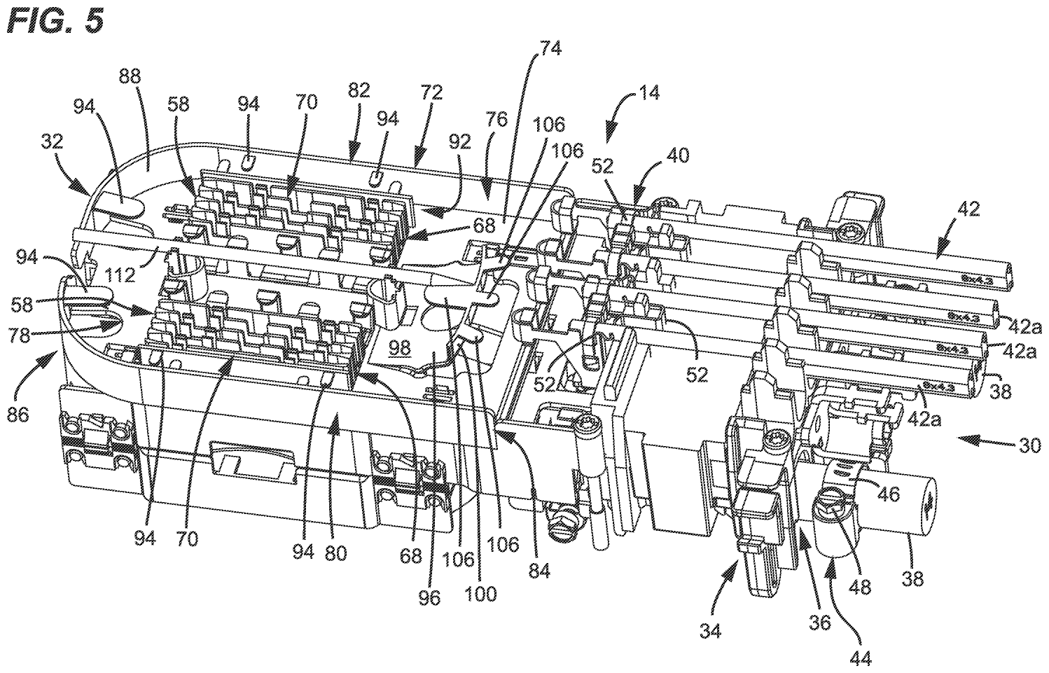

Referring to FIGS. 4-7, the management unit 14 is elongate along a major axis B that is parallel to the major axis A of the housing 12 when the management unit 14 is mounted within the interior of the housing 12. The major axis B of the management unit 14 extends along a length of the management unit 14 between a first end 30 and an opposite second end 32 of the management unit 14. The management unit 14 provides cable anchoring functionality for providing strain relief for cable attachment within the telecommunications enclosure 10. For example, the management unit 14 includes a support infrastructure 34 (e.g., a fiber anchoring region) with a first anchor location 36 at the first end 30 of the management unit 14 for mounting (e.g., securing, attaching, fixing, anchoring, etc.) feeder cables 38 (e.g., pass-through cables) at the rear of the support infrastructure 34 and a second anchor location 40 provided at the first end 30 of the management unit 14 for mounting drop cables 42 to the rear of the support infrastructure 34. In one example, buffer tubes corresponding to the feeder cables 38 can be anchored to a second major side of the management unit 14 while buffer tubes corresponding to the drop cables 42 can be anchored to a first major side of the management unit 14.

In certain examples, the management unit 14 can also include structure for attachment of cable strength members (e.g., flexible yarn-like strength members such as Aramid yarn or more rigid strength members such as a fiberglass re-enforced epoxy rods) to anchoring locations fixed relative to the telecommunications enclosure 10.

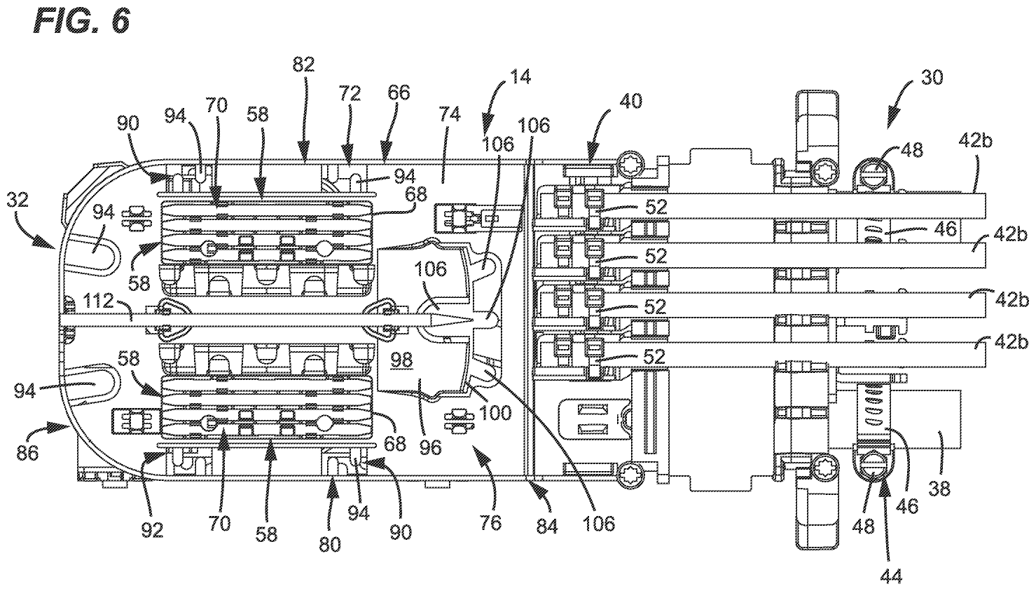

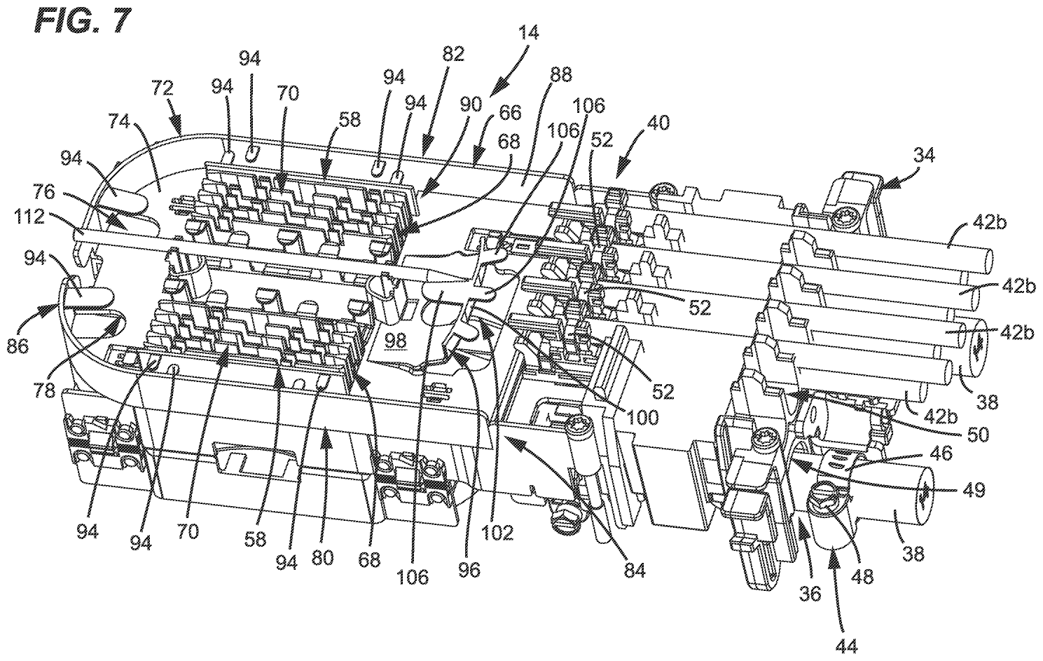

Still referring to FIGS. 4-7, the management unit 14 is depicted with four flat drop cables 42a, although alternatives are possible. FIGS. 6-7, show the management unit 14 with eight round drop cables 42b stacked on top of each other.

In use, the feeder cables 38 are routed through a first cable entry 49 (see FIG. 7) and to be anchored to the rear of the support infrastructure 34 by first cable anchors 44. The first cable anchors 44 can include clamping bands 46 (e.g. a hose clamp) that can be expanded and contracted through the use of actuation structures 48, such as, screws. The drop cables 42 can be routed through a second cable entry 50 to be anchored to the support infrastructure 34 by second cable anchors 52. For example, ends of buffer tubes corresponding to the feeder cables 38 can be anchored to a bottom side of the support infrastructure 34 and ends of buffer tubes corresponding to the drop cables 42 can be anchored to a top side of the support infrastructure 34.

In certain examples, the first and second cable anchors 44, 52 can provide a cable grounding function and can be electrically connected to electrical components (e.g., shields) of the feeder/pass-through cables if such shields are present.

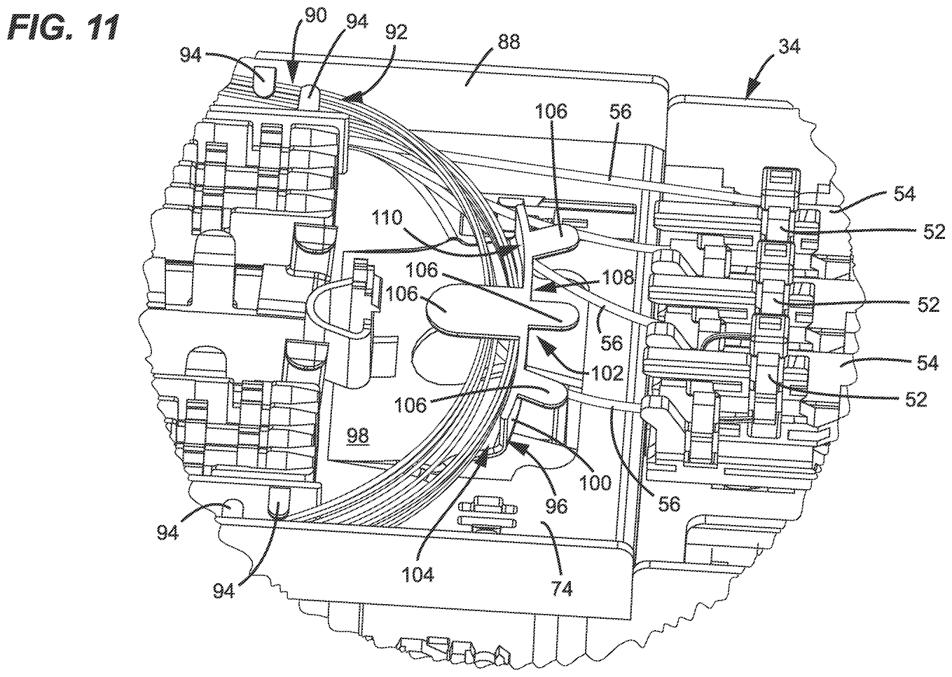

The drop cables 42 can include a buffer tube 54 (see FIG. 11), an optical fiber 56 (see FIG. 11), and strength layers (not shown). In certain examples, the optical fibers 56 of the drop cables 42 can be cut and spliced to feeder fibers or to passive optical splitters 58. The buffer tube 54 can be used to protect the optical fibers 56 as the optical fibers 56 extend from jacketed ends of the drop cable to the splice tray 66. The ends of the buffer tubes corresponding to the optical fibers of the multi-fiber optical cable are typically anchored to the management unit 14.

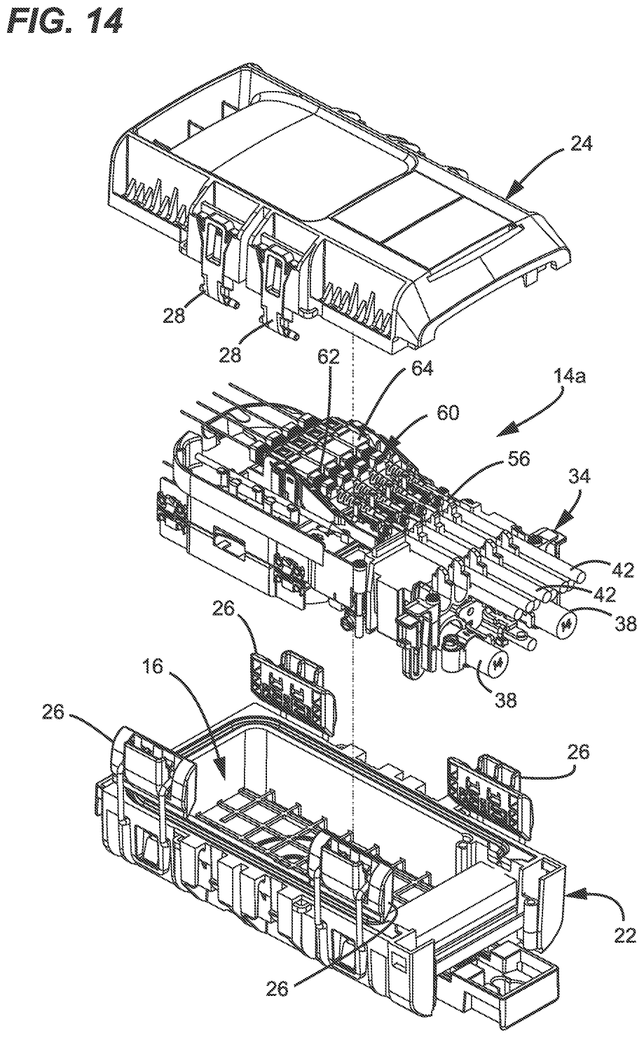

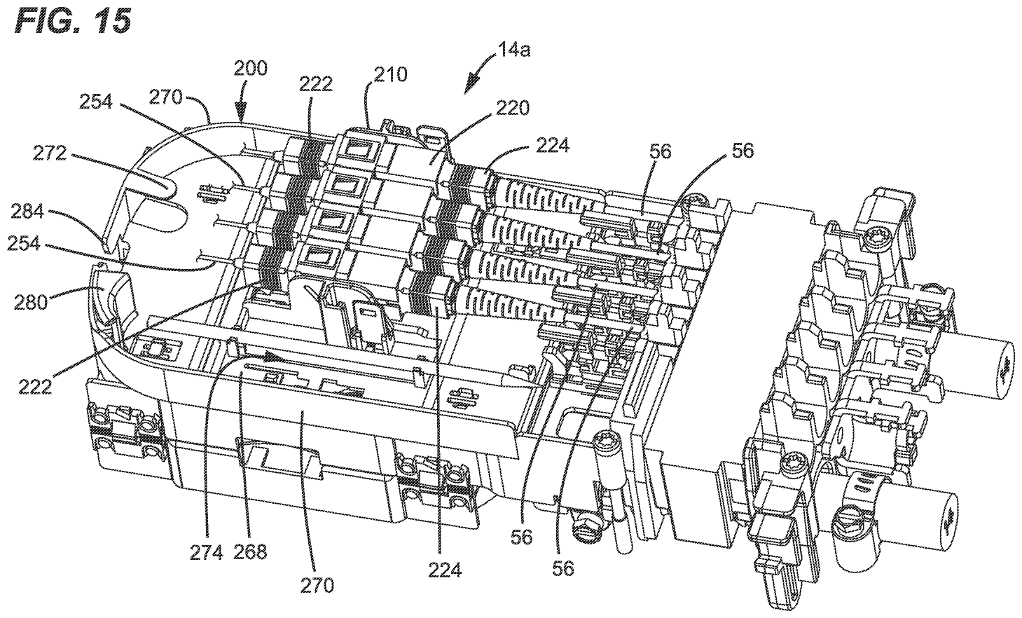

In certain examples, a management unit 14a can also provide connectorized patching capabilities that may include dematable optical connection locations between optical fibers of drop cables and optical fibers of feeder or pass-through cables (see FIG. 14). In certain examples, the dematable fiber optic connection locations can include fiber optic connectors (e.g., SC connectors. LC connectors, etc.) interconnected by fiber optic adapters 64. That is, the optical fibers 56 of the drop cables 42 may have connectorized ends 60 that plug into ports 62 of fiber optic adapters 64 (see FIG. 14).

Still referring to FIGS. 4-7, the management unit 14 can include a splice tray 66 with optical component locations 68 (e.g., optical splicing locations) such as slots, fingers, pockets, receptacles, or the like for supporting splice holder modules 70. The splice holder modules 70 can each be secured to the splice tray 66 by a snap-fit interface, such as a mechanical connection interface. The splice holder modules 70 can protect fusion splices between drop cables and fibers of a through cable. The splice tray 66 is positioned adjacent the support infrastructure 34. It will be appreciated that the splices may be single fiber splices or mass-fusion splices. In certain examples, the splice tray 66 of the management unit 14 can also include passive optical power splitting and/or wavelength division multiplexing capabilities. For example, the splice tray 66 of the management unit 14 may support the passive optical splitters 58 for power splitting optical signals from feeder cables 38 and directing the power split signals to drop cables 42, or may include wavelength division multiplexers for separating optical signals from feeder cables 38 based on wavelength and directing the separated signals to separate drop cables 42. Optical fibers of the feeder cables 38 can be cut and spliced to the optical fibers 56 of the drop cables 42. That is, the passive optical splitters 58 on the splice tray 66 are capable of splicing optical fibers of feeder cables 38 either directly to optical fibers of drop cables 42 or to connectorized optical pigtails that are routed to the dematable connection locations of the management unit 14. In still other examples, the optical component locations 68 can be configured for holding the fiber optic adapter 64 or a bank of fiber optic adapters suitable for mechanically optically coupling together fiber optic connectors (see FIG. 14).

The splice tray 66 includes a main tray body 72 that includes a base panel 74 having a top side 76 and an opposite bottom side 78. The splice tray 66 has a length L (see FIG. 4) that extends along the major axis B of the management unit 14 and a width W that extends perpendicular to the major axis B of the management unit 14. The splice tray 66 can be elongated along the length L of the splice tray 66 so as to have a racetrack-type configuration. The base panel 74 has a first side 80, an opposite, second side 82, a tray first end 84, and an opposite, tray second end 86. The first and second sides 80, 82 can extend between the tray first and second ends 84, 86. The tray first and second ends 84, 86 can be separated by the length L of the splice tray 66. The support infrastructure 34 can be located at the tray first end 84 of the base panel 74. The optical component locations 68 are on the top side 76 of the base panel 74 between the first and second sides 80, 82 of the base panel 74. The optical component locations 68 are configured for receiving and retaining the splice holder modules 70 at the top side 76.

The splice tray 66 is not limited to splicing functionality. For example, the splice tray 66 also includes fiber management functionalities such as fiber routing functionality. In certain examples, the splice tray 66 can provide for management of optical fibers 56 accessed from drop cables 42 which are adapted to be optically coupled to fibers corresponding to feeder cables 38.

The splice tray 66 can include fiber guide structures such as fiber guide walls 88 that project upwardly from the top side 76 of the base panel 74 to define a fiber routing path 92. The fiber guide walls 88 can be curved at the first and second 84, 86. That is, the fiber guide walls 88 define curved ends of a fiber loop-storage region 90 (e.g., one or more fiber loops) defined by the top side 76 of the splice tray 66 and the side walls 80, 82 define opposite sides of the fiber loop-storage region 90. The fiber guide walls 88 also define channel portions that extend along the side walls 80, 82 of the fiber loop-storage region 90. The fiber guide walls 88 function as fiber guides and have curvatures compatible with minimum bend radius requirements of the optical fibers intended to be managed on the splice tray 66. The fiber loop-storage region 90 can be provided in the fiber routing path 92 that extends around a perimeter of the splice tray 66. In certain examples, the fiber-routing path 92 can be provided at both the first and second sides 80, 82 of the splice tray 66. In certain examples, fiber routing paths can be defined by dividers, separators, and/or fiber bend radius limiters for guiding optical fibers along the routing paths and for preventing the optical fibers from being bent beyond pre-defined bend radius limitations. The splice holder modules 70 can be mounted at the optical component locations 68 positioned inside the boundary defined by the fiber loop-storage region 90.

The fiber loop-storage region 90 can be elongated along the length L of the splice tray 66. In certain examples, the base panel 74 may include pass-throughs in the fiber routing path 92 that allow optical fibers to be routed between different layers or sides of the management unit 14. For example, the pass-through openings can be used to route optical fibers corresponding to the feeder/pass-through cables to the splice tray 66.

Fiber retaining structures 94 such as tabs, fingers or like structures can be provided on the fiber guide walls 88 that project over the fiber loop-storage region 90 to provide fiber retention and for retaining optical fibers within the fiber routing path 92. Also, bend radius protection structures can be provided for retaining optical fibers within the fiber routing path 92. In certain examples, the splice tray 66 may include fiber guide structures that also support other routing paths such as a figure eight pattern and a partial loop.

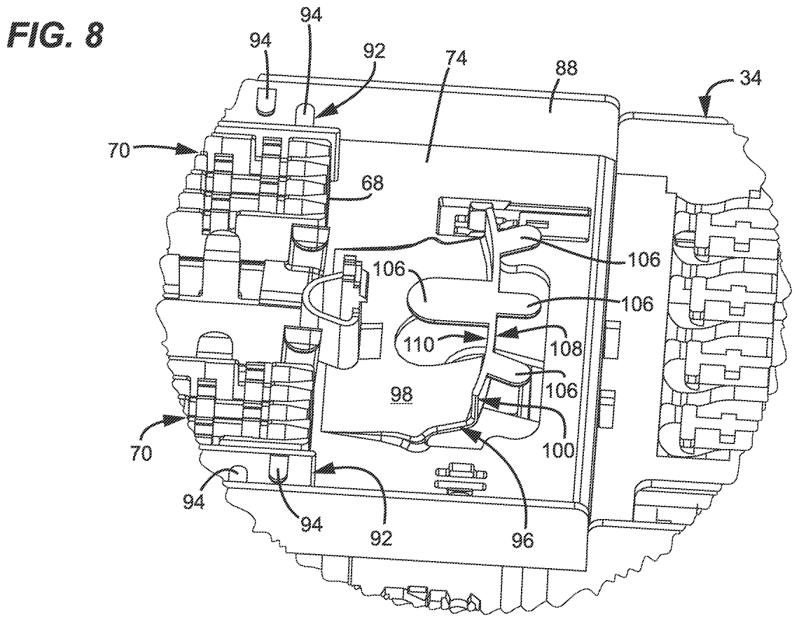

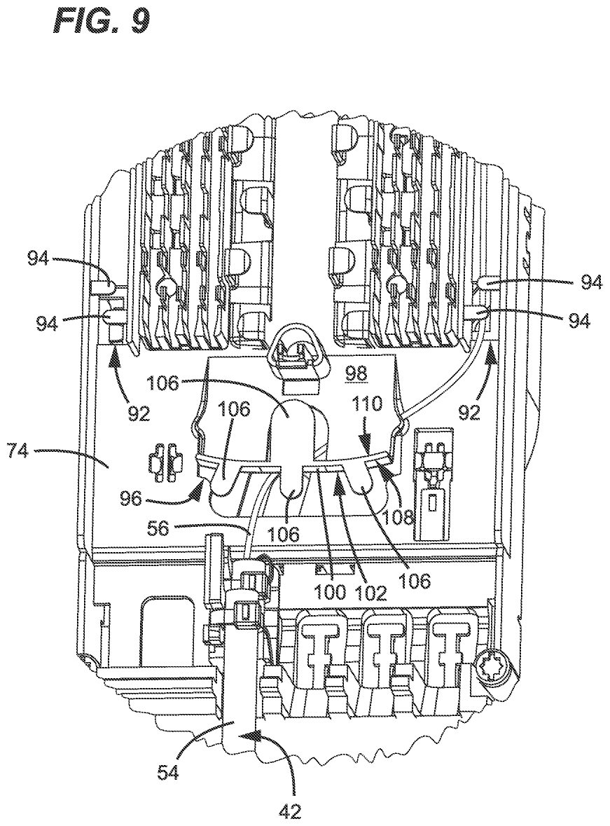

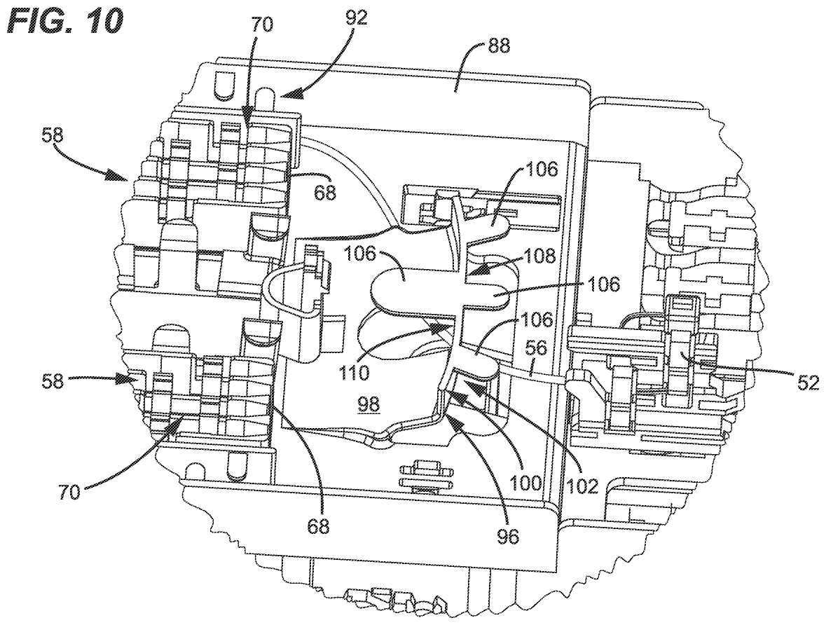

Turning to FIGS. 8-10, bend radius protection structures can also be provided on the splice tray 66 for preventing excessive bending of optical fibers on the splice tray 66. It is preferred for fibers to be routed at locations that limit fiber stress as the fibers extend from the buffer tube 54 of the drop cables 42. In such an example, the drop cables 42 each have a jacket containing a plurality of optical fibers (e.g., 12 optical fibers). Of course, cables having different numbers of fibers can be utilized and different counts of optical fibers can be managed on the splice tray 66 without departing from the principles of the present disclosure. Generally, the jacket is stripped away from the optical fibers 56 and the splice tray 66 is used to manage the optical fibers 56.

The interior of the splice tray 66 includes a bend radius limiter 96 for routing optical fibers 56 of the drop cables 42. The bend radius limiter 96 is positioned adjacent the support infrastructure 34. Typically, the lowest cable positioned on the support infrastructure 34 can be routed onto the splice tray 66 with space for a minimum bend radius of at least about 10 mm (millimeters), the absolute minimum required. That is, the optical fibers extending from drop cables can be bent around a typical bend radius limiter to be routed into a fiber routing path on a tray. In certain examples, there may be limited space between the drop cables and the bend radius limiter which may limit the bend radius of the optical fibers being routed on the splice tray. Such a configuration can yield a high risk of optical losses. In addition, when drop cables are not attached perfectly on an enclosure, there may be a risk of optical losses for the optical fibers extending therefrom.

The advantageous feature of the bend radius limiter 96 according to the present disclosure is that more space can be created for larger bend radius control of the optical fibers 56 extending from the support infrastructure 34, which results in a lower risk of optical losses. That is, by lifting the base panel 74 at the bend radius limiter %, more space can be created underneath the bend radius limiter 96 for preventing the optical fibers 56 from being bent beyond pre-defined bend radius limitations. The optical fibers 56 can extend from a low position on the support infrastructure 34 or from the furthest side of the splice tray 66 to be routed to the fiber routing path 92 with low risk of optical loss. In certain examples, the bend radius is about 25 mm. In certain examples, the bend radius is about 20 mm. In certain examples, the bend radius is at least 15 mm.

The bend radius limiter 96 can include a raised support member 98 and an inner guide wall 100 that projects upwardly from the raised support member 98. The raised support member 98 can be elevated with respect to the base panel 74 such that the bend radius limiter 96 is offset upwardly from the base panel 74 to define a cable routing pathway 102 beneath the raised support member 98. Optical fibers 56 can be routed underneath the raised support member 98 to prevent the optical fibers 56 from bending beyond pre-defined bend radius limitations as the optical fibers 56 route from the support infrastructure 34 along the cable routing pathway 102. The cable routing pathway 102 can extend from the support infrastructure 34 to the fiber loop-storage region 90.

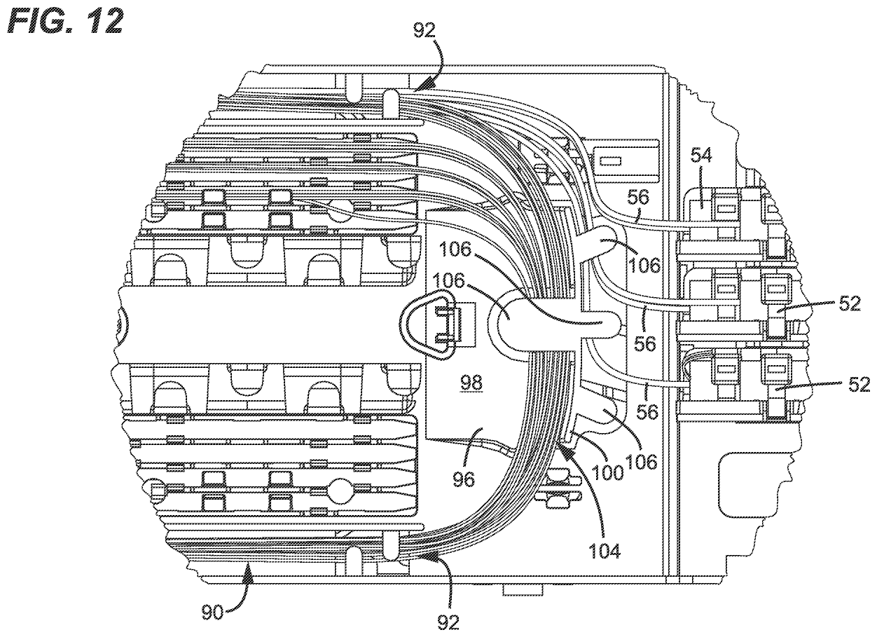

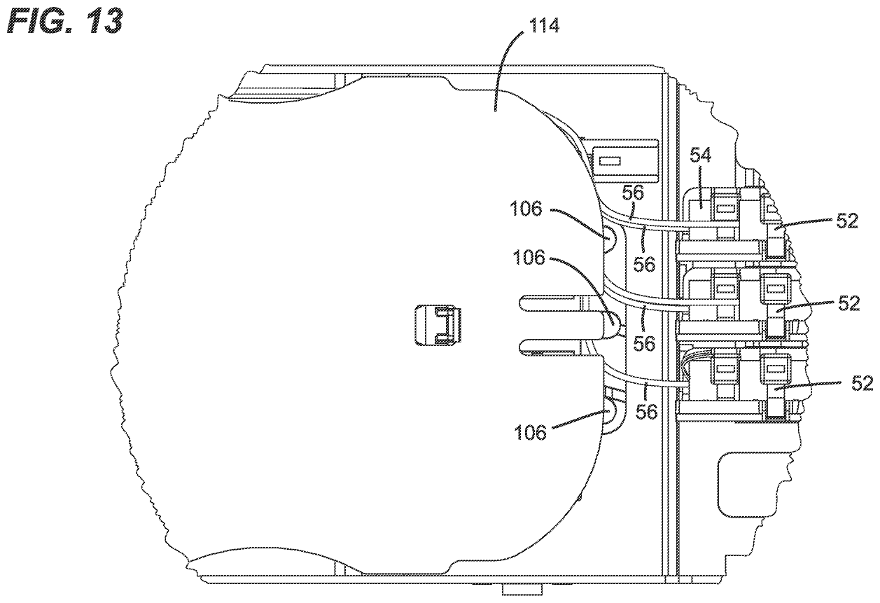

Turning to FIGS. 11-13, the inner guide wall 100 of the bend radius limiter 96 may define a fiber routing pathway 104 that corresponds with the fiber loop-storage region 90. The inner guide wall 100 can include at least one fiber management tab 106 that projects laterally outwardly from each opposing side 108, 110 of the inner guide wall 100 for retaining the optical fibers 56 that are being lead from the support infrastructure 34 within the fiber-storage region 90. As depicted, there are three fiber management tabs 106 on side 108 and one fiber management tab on side 110, although alternatives are possible. The fiber management tabs 106 can vary in size and geometry. In certain examples, the fiber management tabs 106 may be removable, snap-on structures. In certain examples, the fiber management tabs 106 can be provided on the fiber guide walls 88 or cooperate with additional cable management fingers for retaining the optical fibers 56 within the fiber-storage region 90. The optical fibers 56 can be routed onto the splice tray 66 such that any excess fiber length can be coiled at the fiber-storage region 90.

In certain examples, the splice tray 66 includes a handheld element 112 or a tool, such as a fiber pick, for managing the optical fibers 56 on the splice tray 66. In certain examples, a cover 114 can be removably attached to the splice tray 66.

As noted above, in some closures drop cables may be connectorized with a fiber optic connector on the end inside of the enclosure to mate with a fiber optic adapter and another connector inside of the enclosure. The noted management unit 14a of FIG. 14 can provide the connectorized patching capabilities that may include dematable optical connection locations between optical fibers of drop cables and optical fibers of feeder or pass-through cables. In certain examples, the dematable fiber optic connection locations can include fiber optic connectors (e.g., SC connectors. LC connectors, etc.) interconnected by fiber optic adapters 64. That is, the optical fibers 56 of the drop cables 42 may have connectorized ends 60 that plug into ports 62 of fiber optic adapters 64 (see FIG. 14).

Instead of splice tray 66, a patch tray 200 is then used for mating of cables in a patch function with adapters and connectors for management unit 14a. Patch tray 200 includes an adapter holder 210 for holding a plurality of adapters 220. Adapters 220 allow for connectors 222, 224 to be mated for optical signal transmission. Adapter 220 may be mounted on a moveable mount to selectively improved adapter and connector access for mating and demating, such as in PCT International Patent Application No. PCT/US2019/017904 filed on Feb. 13, 2019, published as WO2019/160995 noted above.

Patch tray 200 includes a longitudinal tray axis 230 with a first end 232 adjacent to cable anchor region 234. An opposite second end 236 is opposite to first end 232 along longitudinal axis 230. Drop cables 42 exit closure 10.

Patch tray 200 defines an open cable area 260 adjacent to second end 236. A loop storage pocket 266 is in communication with open cable area 260 underneath base 268 of adapter holder 210. Open cable area 260 includes a wall 270 for storing cable loops in a protected manner. Wall 270 includes a tab 272 overhanging open cable area 260 for managing the interior fibers 254 and related fiber cable loops 256. A radius limiter 280 may be provided to assist with managing of the fibers 254 and the fiber cable loops 256. An opening 284 allows for cables 254 to extend from open cable area 260 to another area in the management unit 14a.

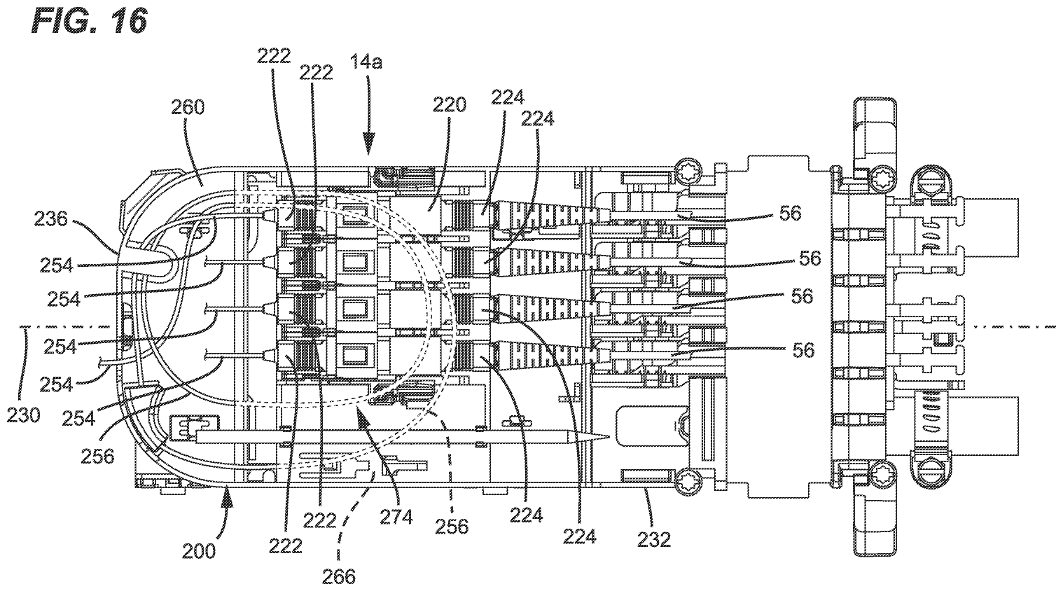

The patch tray 200 includes an offset or asymmetric location for the adapter holder 210 and adapters 220 for connection with mating fiber optic connectors of cables managed on an organizer. The adapter holders are asymmetrically positioned with respect to a longitudinal axis 230 of the patch tray. An open area 274 on tray 200 does not position any adapters in that area. Cables/fibers 254 extending from the adapter holder 210 in a direction opposite a cable entry location for cables 56 are stored in loops at an upper end of the patch tray. An opening at the upper end of the patch tray allows for those cables to extend to other areas of the organizer. A pocket under the adapter holder further receives the storage loops. Due to the asymmetric location of adapters 220, cables/fibers 254 can all generally follow a similar counterclockwise path in the example show to create storage loops 256, leading then to outlet opening 284, without excessive bending of cables/fibers that might be located also in area 274. As open cable area 260 gets smaller, such as in the case of smaller enclosures, the more likely sharper bends are required for the fibers and fiber loops to transition to other areas on management unit 14a (e.g. other levels). See FIG. 16.

As shown, open cable area 260 including tab 272 and radius limiter 280 are not symmetrically arranged or shaped about the tray axis 230.

The noted management unit 14, 14a in the examples provided are similar in that the incoming cables and outgoing cables are secured to the telecommunications enclosure 10, and the cables and fibers are managed by the management units 14, 14a. Management unit 14 includes a splice tray 66 for connecting feeder fibers for other fibers to the drop fibers and cables. Management unit 14a instead includes a patch tray 200 for connecting connectorized internal fibers to connectorized drop fibers and cables. The other example structures shown in the FIGS. below the respective splice tray 66 and patch tray 200 can include further trays for splices, loop storage, splitters, and other devices for managing, connecting and protecting the fibers and cables.

From the forgoing detailed description, it will be evident that modifications and variations can be made without departing from the spirit and scope of the disclosure.

1. A fiber management tray comprising:
a main tray body including a base panel having a top side and an opposite bottom side, the fiber management tray being elongated along a length of the fiber management tray, the base panel having opposite first and second sides extending between opposite first and second ends, the first and second ends being separated by the length of the fiber management tray;
fiber guide walls that project upwardly from the top side of the base panel;
a cable anchoring region located at the first end of the base panel;
optical splicing locations on the top side of the base panel between the first and second sides of the base panel, the optical splicing locations configured for receiving and retaining splice holders;
a fiber loop-storage region defined by the fiber guide walls on the top side of the base panel, the fiber loop-storage region being elongated along the length of the fiber management tray; and
a bend radius limiter positioned adjacent the cable anchoring region, the bend radius limiter including a raised support member elevated with respect to the base panel such that the bend radius limiter is offset upwardly from the base panel to define a cable routing pathway beneath the raised support member from the cable anchoring region to the fiber loop-storage region, the bend radius limiter also including an inner guide wall that projects upwardly from the raised support member to define a fiber routing pathway that corresponds with the fiber loop-storage region, the inner guide wall including at least one fiber management tab that projects laterally outwardly from each opposing side of the inner guide wall.

2. The fiber management tray of claim 1, wherein the at least one fiber management tab includes a fiber tab that extends in a first direction over fibers routed along the fiber routing pathway to retain the fiber on the fiber management tray.

3. The fiber management tray of claim 2, wherein the at least one fiber management tab includes three cable management tabs that extend in a second direction over fibers routed along the cable routing pathway.

4. The fiber management tray of claim 1, wherein the bottom side includes a loop storage of uncut buffer tubes of a feeder cable, the bottom side being adapted to anchor the feeder cable thereto.

5. The fiber management tray of claim 1, wherein a gap is defined between the bend radius limiter and the cable anchoring region.

6. The fiber management tray of claim 5, wherein the gap provides a bend radius of at least 15 mm.

7. The fiber management tray of claim 5, wherein the gap provides a bend radius of at least 20 mm.

8. The fiber management tray of claim 1, wherein the splice holders define outer channels that form part of an exterior pathway along which fiber lengths are routed in the fiber loop-storage region.

9. The fiber management tray of claim 1, further comprising fiber optic cables including an outer jacket, the outer jacket of the fiber optic cables being anchored at the cable anchoring region, an inner jacket of the fiber optic cables being routed along the cable routing pathway.

10. The fiber management tray of claim 9, wherein the fiber optic cables include at least two optical fibers.

11. The fiber management tray of claim 9, wherein the fiber optic cables include at least twelve optical fibers.

12. A fiber management tray comprising:
a main tray body including a base panel having a top side and an opposite bottom side, the base panel having opposite first and second sides extending between opposite first and second ends;
fiber guide walls that project upwardly from the top side of the base panel to define a fiber loop-storage region on the top side of the base panel;
a cable anchoring region located at the first end of the base panel; and
a bend radius limiter positioned adjacent the cable anchoring region, the bend radius limiter including a raised support member elevated with respect to the base panel such that the bend radius limiter is offset upwardly from the base panel to define a cable routing pathway beneath the raised support member from the cable anchoring region to the fiber loop-storage region, the bend radius limiter also including an inner guide wall that projects upwardly from the raised support member to define a fiber routing pathway that corresponds with the fiber loop-storage region, the inner guide wall including at least one fiber management tab that projects laterally outwardly from each opposing side of the inner guide wall.

13. The fiber management tray of claim 12, wherein the base panel includes optical component locations on the top side thereof.

14. The fiber management tray of claim 12, wherein the base panel includes optical splicing locations configured for receiving and retaining splice holder modules.

15. The fiber management tray of claim 13, wherein the base panel includes dematable fiber optic connection locations having fiber optic connectors interconnected by fiber optic adapters.

16. A fiber management tray comprising:
a main tray body including a base panel having a top side and an opposite bottom side, the base panel having opposite first and second sides extending between opposite first and second ends;
fiber guide walls that project upwardly from the top side of the base panel to define a fiber loop-storage region on the top side of the base panel; and
a bend radius limiter, the bend radius limiter including a raised support member elevated with respect to the base panel such that the bend radius limiter is offset upwardly from the base panel to define a cable routing pathway beneath the raised support member to the fiber loop-storage region, the bend radius limiter also including an inner guide wall that projects upwardly from the raised support member to define a fiber routing pathway that corresponds with the fiber loop-storage region, the inner guide wall including at least one fiber management tab that projects laterally outwardly from each opposing side of the inner guide wall.

17. A fiber management tray comprising:
a base extending between a first end and an opposite second end, the base including first and second opposite sides extending generally between the first and second ends, wherein the tray defines a longitudinal axis extending between the first end and the second end and generally parallel to the first and second sides;
a plurality of adapters mounted to the base;
a plurality of connectors mounted to the plurality of adapters;
an open cable area located adjacent to the second end of the base; and
a loop storage pocket under the plurality of adapters and in communication with the open cable area;
wherein the plurality of adapters are in a group and the group is asymmetrically positioned relative to the longitudinal axis, and wherein each adapter includes an adapter axis generally parallel to the longitudinal axis of the base.

18. The fiber management trays of claim 1, further comprising a closure and a plurality of drop cables extending into the closure and being connected to internal cables of the closure on the fiber management tray by splices and/or connectors.
